(19) United States
(12) Patent Application Publication
(10) Pub. No.: US 2017/0172325 A1
(43) Pub. Date: Jun. 22, 2017

(54) PHOTO DISPLAY

(71) Applicant: Caretek, Inc., Denver, CO (US)

(72) Inventor: Daniel GREENE, Denver, CO (US)

(21) Appl. No.: 15/386,557

(22) Filed: Dec. 21, 2016

Related U.S. Application Data
(60) Provisional application No. 62/270,579, filed on Dec. 21, 2015.

(51) Int. Cl. A47G 1/06; B41J 3/407; B41F 17/00; B44D 3/18

(52) U.S. Cl. CPC A47G 1/0633; B44D 3/185; B41J 3/407; B41F 17/00

(57) ABSTRACT

A photo display including a photo substrate and a support structure. The photo substrate has an image printed on a first surface. The support structure can include a rectangular central sheet, four base side strips, four internal side strips, four back strips, and four external side strips for forming a closed support structure. The photo substrate can be secured to an external surface of the front of the central sheet so that the front central sheet forms a rigid backing for the photo substrate.

### CROSS REFERENCE TO RELATED APPLICATIONS

This application claims priority to U.S. Provisional Application No. 62/270,579 filed Dec. 21, 2015, the contents of which are incorporated herein by reference in their entirety.

### FIELD

The present disclosure relates to a photo display, and more particularly to a display resembling an artist's canvas mounted on a wooden stretcher frame.

### BACKGROUND

Wooden stretcher frames for mounting painted or printed images have been provided. Photo substrates for use with such frames include artist's canvas. The photo substrate is typically stretched over the wooden stretcher frame, secured to the backside of the frame with staples or other hardware, and externally folded at the corners of the frame. Other support structures not constructed from wood but when having a photo substrate mounted thereon has the appearance of a wooden stretcher bar frame have been additionally provided. Unfortunately, such support structures are typically expensive or do not provide a mounted image that is professional in appearance. Additionally, such artist's canvases are expensive. There is a need for new support structures and photo substrates that address such disadvantages.

### BRIEF DESCRIPTION OF THE DRAWINGS

FIG. 1 depicts a back perspective or rear view of the photo display of the present disclosure. Grooves along the edges of the photo display allow for folding of the support to form a frame structure. The attached photo substrate and/or canvas-like material are cut to facilitate folding without excess material exposed at the corners. Holes through the support and attached photo substrate and/or canvas-like material allow for hanging of the photo display on a wall.

FIG. 2 depicts a complete rear view of the photo display in its unfolded position. Grooves run horizontally along the top and the bottom edges of the photo display and vertically along the left and right edges of the photo display. Two holes may be made through the support and attached photo substrate and/or canvas-like material at opposite edges to allow for hanging of the photo display vertically or horizontally. The position of the holes will depend on the orientation of the photo or image on the front of the photo display.

FIG. 3 depicts the easy folding of the support and attached canvas-like material on one edge of the photo display. The figure shows the lack of any excess photo substrate and/or canvas-like material protruding at the corner from the folded support.

FIG. 4 depicts a complete rear view of the photo display in its folded position. The corners of the folded support fit neatly together and the edges provide a frame structure that supports the attached photo substrate and/or canvas-like material and allows for display of the image or photo on the photo substrate and/or canvas-like material.

FIG. 5 depicts a front perspective or front view of an image printed onto the photo substrate and/or canvas-like material and attached to the underlying support of the photo display. The photo display may be mounted on a wall without further modification.

### DETAILED DESCRIPTION

The present disclosure is directed to visual art or images which are to be displayed, for example, as wall-hung pictures. The present disclosure also relates to photo displays. More particularly the disclosure relates to several embodiments of images mounted on support structures. The images may be printed on a canvas base and the canvas may be mounted on a support structure giving the appearance similar to that of an artist's canvas stretched over a stretcher bar frame. In some embodiments, the images may be digitally printed and the canvas may be adhered to a backing. The backing may include display hardware for positioning the image substantially upright for viewing.

Original oil or acrylic paintings are conventionally painted on canvas that is stretched over a rectangular, open framework and tacked to it, and are displayed by hanging the framework whether directly or when retained within a peripheral frame, on a wall. Where reproductions of the painting are printed off sheet-material, for example on good-quality paper, canvas or material simulating canvas, the sheet-material may be similarly retained stretched over an open framework.

It is one of the objects of the present disclosure to provide a form of mounted item of photo or visual art that may be used with advantage for reducing costs.

The disclosure is applicable to the mounting of a printed picture economically, but in a way that will enable it to be displayed, for example in the manner of an original painting, hanging on a wall. In this regard, the mounted picture may have the general form of a picture block with an appearance simulating that of an original painting on canvas retained on a stretcher frame.

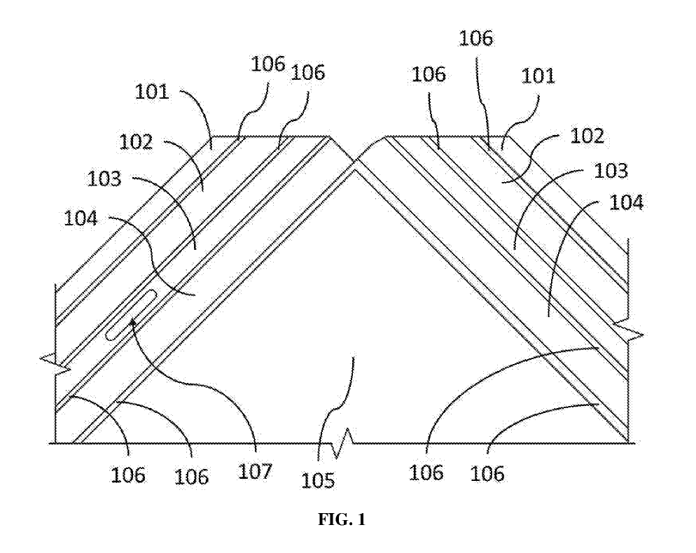

Photo displays in accordance with the present disclosure will now be described, by way of example with reference to the accompanying drawings. FIG. 1 depicts the unfolded photo display in which pre-formed grooves 106 allow easy folding to form a frame structure and a photo substrate 110 and/or canvas-like material is attached to the front of the frame structure or support structure.

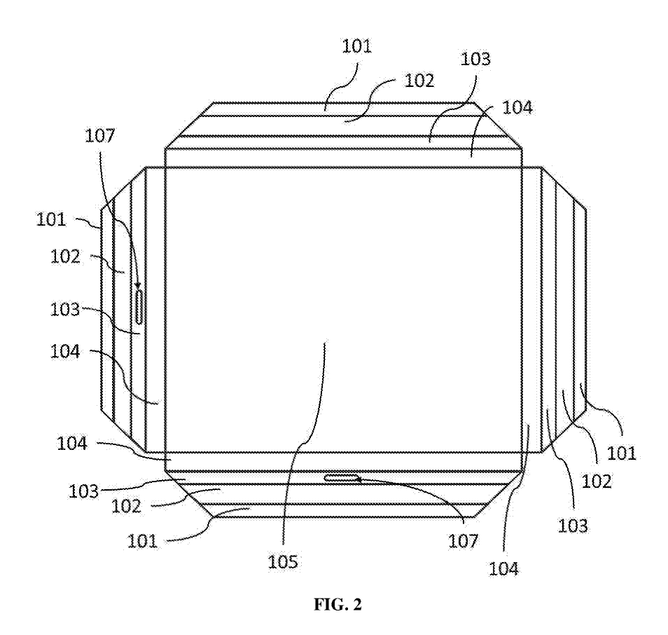

FIG. 2 shows the rear view of the unfolded photo display. The photo display comprises a photo substrate 110 having opposite first and second surfaces and a central and peripheral portions, an image printed on the first surface, a support structure including a rectangular central sheet 105, four base side strips 101, four internal side strips 102, four back strips 103, four external side strips 104, the central sheet 105 having a front and a rear and four edges at its periphery and the external side strips 104 extending alongside respective edges of the central sheet 105 at a right angle to the central sheet 105, the external side strips 104 having respective opposite ends extending end-to-end to form four external corners 108, the back strips 103 extending along respective external side strips 104 at a right angle to the external side strips 104, the back strips 103 having respective opposite ends extending end-to-end overlying the periphery of the central sheet 105, the internal side strips 102 extending along respective back strips 103 at a right angle to the back strips 103, the internal side strips 102 having respective opposite ends extending end-to-end to form four internal corners 109, the base side strips 101 extending along respective internal side strips 102 at a right angle to the internal side strips 102, the base side strips 101 having respective opposite ends extending end-to-end and lying flat against the central sheet 105, the central sheet 105, four base side strips 101, four internal side strips 102, four back strips 103, four external side strips 104 being made of paperboard, cardboard, fiberboard, wood, metal, plastic, or a combination thereof, the second surface of the photo substrate 110 adhered to the front of the central sheet 105 so that the central sheet 105 forms a rigid backing for the central portion of the photo substrate 110 and the peripheral portions of the photo substrate 110 adhered to the external side strips 104 and back strips 103, securement means for coupling the four base side strips 101 to the central sheet 105 and/or holding the four external corners 108 and the four internal corners 109 in place. Holes 107 may also be inserted into the support structure and attached photo substrate 110 to allow for hanging of the photo display vertically or horizontally.

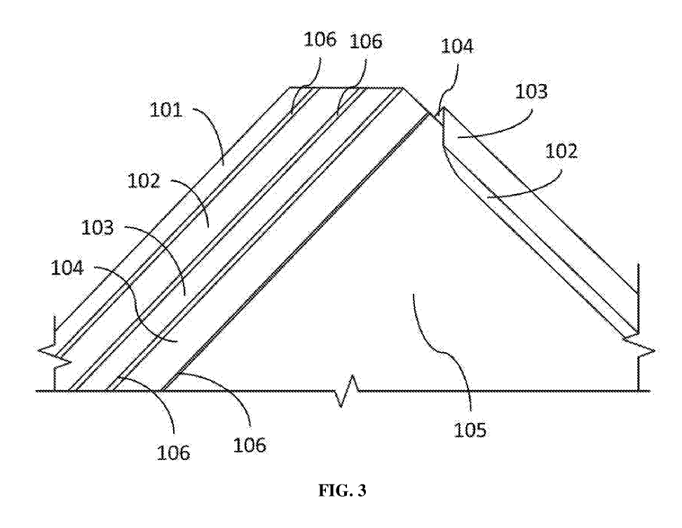

FIG. 3 presents a partially folded photo display. The photo substrate 110 is cut to match the shape of the frame structure or support structure allowing easy folding without excess material from the photo substrate 110 at the corners of the photo display.

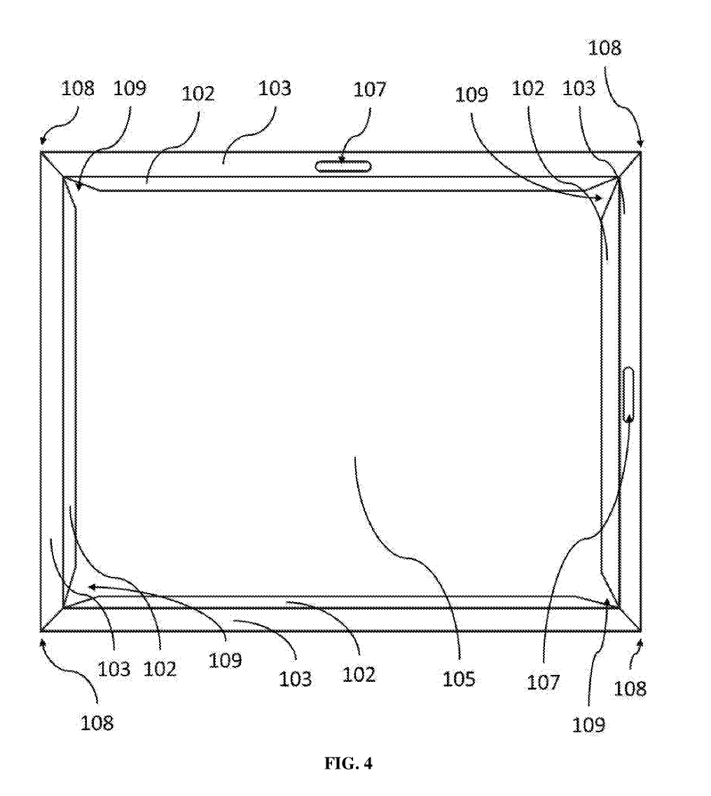

FIG. 4 presents a back perspective or rear view of the photo display in its fully folded form. The configured photo display may be easily hung from a surface to display the photo substrate 110 attached to the front surface of the photo display.

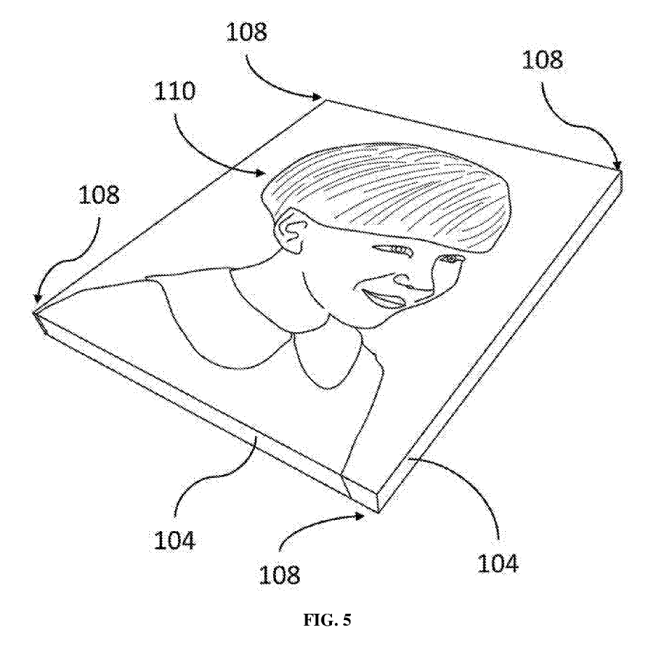

FIG. 5 depicts a front perspective of the photo display. A textured photo substrate 110 may be used as shown in FIG. 5 to add to the aesthetic value of the image display. In certain aspects, the photo substrate 110 includes a textile-like material. The textile-like material may include a layer of woven textile. In other aspects, the photo substrate 110 is an artist canvas.

In certain aspects, securement means are glue or staples. Yet, other securement means include nails, tape, and clips.

The image on the photo substrate 110 may be printed using, for example, digital printing, offset lithography, letterpress, flexography, gravure, silk-screening, blocking, embossing and/or thermography, in single or multiple colors. The printing may extend throughout the whole of the photo substrate 110, or may be confined to part, or parts, of it. Furthermore, the printed surface may be of smooth finish or, whether embossed before or after printing, may have a relief texture (for example, giving the appearance of canvas, linen or other woven fabric, wood, slate or stone), and may be coated with a protective varnish or laminated with a protective film.

Many of the operations of cutting, folding and gluing involved in the manufacture of the base structures of the photo display described above may be carried out manually or with the use of existing machinery already known in the art.

Regarding the photo substrate 110, the photo substrate 110 may be selected from several media used for imparting an image thereon. The photo substrate 110 may be configured for receiving and holding an image imparted thereon and may be selected in conjunction with the ink, paint, or other pigment-carrying medium to suitably present the image. That is, consideration can be given to the crispness, or alternatively blurriness, desired in the image in the selection of the combination of media.

The photo substrate 110 may also be configured for forming to a shape. As such, the photo substrate 110 may be relatively thin and freely flexible such that it may be formed, folded, creased, or otherwise adapted to engage the support structure without cracking, splitting, tearing, or showing undue stress. In one embodiment, the photo substrate 110 may be formed from any suitable material and can, for example, be a membranous material in the form of a layer of thin plastic, film, textile, foil, or paper material. The photo substrate 110 may include first and second surfaces. The first surface is preferably print receptive. Other materials can also be used for forming the photo substrate 110. In one embodiment, the photo substrate 110 can be a textile-like material or artist canvas that can be formed from a layer of a membranous material and an overlying layer of a suitable polymer or plastic on the layer of membranous material. In one embodiment, the layer of membranous material can be a layer of any suitable textile such as a suitable woven textile. The textile can be woven from cotton, polyester, a combination of cotton and polyester or any other suitable material. Alternatively, the layer of membranous material can be a layer or sheet of any suitable nonwoven material or a fibrous material such as paper. The layer of polymer or plastic can have a print-receptive surface for forming first or print surface of the photo substrate 110, or the layer of polymer or plastic can have a print-receptive coating, for example a layer or coating of acrylic or another suitable polymer, thereon for forming first surface of the photo substrate 110. In one embodiment, the layer of polymer, the print-receptive coating or both the layer of polymer and the print-receptive coating can be embossed, so for example to cause the photo substrate 110 to have a suitably textured first surface. In one embodiment where the layer of membranous material is a layer or sheet of any suitable nonwoven material or a fibrous material such as paper, the overlying layer of polymer can be the print-receptive coating and the print receptive coating and the layer of membranous material can be embossed, so for example to cause the photo substrate 110 to have a suitably textured first surface. The first surface can have the appearance of a woven textile such as canvas, and in one embodiment the first surface, and some or all of the layers of photo substrate 110 beneath the first surface, are embossed to have the appearance of a woven textile such as canvas.

The surfaces may be opposite surfaces forming first and second sides of a portion of material. The photo substrate 110 may have a central portion and a peripheral portion or periphery formed for example by one or more edges of the photo substrate 110. The periphery may define a generally rectangular, or triangular shaped photo substrate 110.

An adhesive may be provided for securing the photo substrate 110 to the support structure. The adhesive be applied to the photo substrate 110 and may extend across some or all of the central portion of one of the first or second sides of the photo substrate 110 or entirely across one of the first and second sides of the photo substrate 110. The adhesive may be pre-applied to one or both of the photo substrate 110 and structure support and covered with a tape-backing. Alternatively, the adhesive may not be pre-applied and may be applied to the photo substrate 110 or the structure support or both at the time of securing the photo substrate 110 to the structure support. The adhesive may be applied to a back surface or side of the photo substrate 110 so as to display the image on the opposing or front side. In one embodiment, the adhesive is applied to the entire back side of the photo substrate 110 and the back side of the photo substrate 110 is then pressed to the mounting surface of the support structure. The adhesive can be of any suitable type and can include a polyvinyl acetate, hot melt adhesives and pressure sensitive adhesives.

Regarding the image, the image may be a photograph, a graphic design, a painting, or other image intended to be displayed. The image may be drawn, printed, jetted, developed, or otherwise imparted on the photo substrate 110. Suitable digital printing techniques include inkjet printing and laser printing. The digital printing may impart a pigment-carrying or dye-carrying medium on the photo substrate 110 thereby creating an image. Other printing methods or other processes for imparting an image on a photo substrate 110 may be used.

A clear polymer coating may be applied atop any of the printed images of the display images of the present disclosure. Such a coating can provide a scratch resistant and washable surface over the printed image and protect against cracking and ultraviolet light.

Photo substrate 110 can be of any suitable type, for example photo substrate 110 discussed above. In one embodiment, photo substrate 110 can be a textile-like material that resembles artist's canvas. In one embodiment, photo substrate 110 includes a membranous layer made from any suitable material such as a textile fabric and in one embodiment a suitable woven textile fabric. The membranous or textile layer can be formed from a cotton woven textile, a polyester woven textile or other synthetic or natural fiber woven textile, a linen, or a combination or blend of some or all of the foregoing. In one embodiment, the layer can be formed from a microporous film, for example one which is polyolefin-based with 60% of its weight comprised of non-abrasive filler and 65% of its volume comprised of air. A suitable such film is the TESLIN™ substrate manufactured by PPG Industries of Monroeville, Pa. The woven textile can be a coarse woven textile, such as canvas, an open weave textile, a fine or tightly woven textile, a loosely woven textile or a combination of the foregoing. The weight of the woven textile can range from 2-12 ounces per square yard, and can include woven textiles ranging from 2 to 5 ounces per square yard or from 3 to 4 ounces per square yard, sometimes referred to as light weight woven textiles, woven textiles ranging from 7 to 9 ounces per square yard, sometimes referred to mid-range woven textiles, and woven textiles ranging from 10 to 12 ounces per square yard, sometimes referred to as a heavy-weight woven textiles. In one embodiment, textile layer is formed from a fine, tightly-woven textile, which can be smooth so as to minimize any texture in the layer, and has a weight ranging from 2 to 5 ounces per square yard. Textile or base layer can have a thickness ranging from 0.005 to 0.030 inch and in one embodiment has a thickness of approximately 0.015 inch. Textile or base layer can be printable.

Photo substrate 110 can further include at least one optional plastic layer overlying substrate layer. Such at least one plastic layer can include a plastic or polymer layer overlying base or substrate layer. Suitable plastics include thermoplastics or thermo softening plastics, as well as thermosetting plastics. Layer can be joined or adhered to base layer by any suitable means and in one embodiment can be a preformed or other film that is laminated to the base layer. In one embodiment, the layer can be applied over the base layer as a liquid. In one embodiment, the layer is extruded onto the base layer, for example in the form of a sheet or film and allowed to solidify affixed to the base layer. Suitable materials for plastic or polymer layer include polyurethanes, polyesters, acrylics, vinyl polymers, polyolefins, polyamides, polyethers, epoxy based polymers, cellulosic polymers, polycarbonates and synthetic and natural rubbers, as well as mixtures, blends and copolymers utilizing some or all of the foregoing materials and other materials included to achieve the desired properties of the layer. The polymers may be thermoplastics, thermosets or cross-linked. Examples of thermoset materials include melamine, urea or benzoguanamine formaldehyde polymers, isocyanates and epoxy cross-linked materials. Examples of cross-linked materials include ultraviolet or electron beam cured acrylates, epoxys, vinyl ethers and polyols. The foregoing materials and compositions are not confined to any particular polymer architecture and the polymers can be linear, branched or dendritic. The plastic or polymer layer can have a thickness ranging from 0.0005 to 0.020 inch and in one embodiment has a thickness of approximately 0.001 inch. The thickness and composition of the plastic or polymer layer can be dependent upon factors that can include the composition and any texture of the membranous layer, the depth of any desired emboss of the photo substrate 110, the amount of the material of the polymer layer needed to provide a white or other desired color to the polymer layer, the desired opacity of the layer, any desired anti-fungal, anti-static and/or ultraviolet resistant properties of the layer, the desired rigidity of the layer, the finish of the layer, for example a matte or glossy finish, any desired moisture resistance or barrier coating properties of the layer and any desired darkening effect of the layer when exposed to light. The thickness and composition of the layer can also be chosen to prevent deterioration when the photo substrate 110 is exposed to the environment, for example ultraviolet light or humidity, to provide resistance to chemicals such as household cleaners and sprays and to serve as a flame retardant. Plastic or polymer layer has a top or outer surface.

Photo substrate 110 can optionally include one or more additional layers or coatings overlying the substrate layer. In certain embodiments, substrate layer is printable without the need of a print-receptive coating and thus one or more such additional layers or coatings may not be needed for photo substrate 110. In one embodiment, however, the at least one plastic layer includes a suitable print-receptive coating that can overlie the top surface of substrate layer, or the top surface of plastic or polymer layer. Print receptivity can include all or a combination of any of the following qualities: good adhesion to suitable inks such as water-based inks, solvent-based inks, ultraviolet or UV inks and oil-based inks, whether dye based or pigment based, and any suitable combination of the foregoing inks; good adhesion to toner based printing; a controlled and well defined immediate and long-term dot gain, for example from an ink-jet printer; hold out, for example the retention of the ink on the top surface of the coating or layer and not penetrating into the coating or layer or otherwise losing color strength; and no dot skip, for example undulations may occur in the surface being printed that can cause ink jet drops to be hidden and give the appearance of poor print quality. Where receptivity is to dye-based inks, the dye can be anchored to inhibit or prevent migration or bleed. Suitable print-receptive coatings can include thermoplastics or thermo softening plastics, as well as thermosetting plastics, and can include polyurethanes, polyesters, acrylics, vinyl polymers, polyolefins, polyamides, polyethers, epoxy based polymers, cellulosic polymers, polycarbonates and synthetic and natural rubbers, as well as mixtures, blends and copolymers utilizing some or all of the foregoing materials and other materials included to achieve the desired properties of the coating. The polymers may be thermoplastics, thermosets or cross-linked. Examples of thermoset materials include melamine, urea or benzoguanamine formaldehyde polymers, isocyanates and epoxy cross-linked materials. Examples of cross-linked materials include ultraviolet or electron beam cured acrylates, epoxys, vinyl ethers and polyols. The foregoing materials and compositions are not confined to any particular polymer architecture and the polymers can be linear, branched or dendritic. Coatings can be of any suitable thickness and can range in thickness from 0.001 to 0.020 inch and in one embodiment approximately 0.004 inch. The thickness and composition of the coating can be dependent upon factors that can include the composition and any texture of the membranous layer, the composition and thickness of the plastic or polymer layer, the depth of any desired emboss of the photo substrate 110, the amount of the material of the coating needed to provide a white or other desired color to the coating, the desired opacity of the coating, any desired anti-fungal, anti-static and/or ultraviolet resistant properties of the coating, the desired rigidity of the layer, the finish of the layer, for example a matte or glossy finish, any desired moisture resistance or barrier coating properties of the layer and any desired darkening effect of the layer when exposed to light. The thickness and composition of the coating can also be chosen to prevent deterioration when the photo substrate 110 is exposed to the environment, for example ultraviolet light or humidity, to provide resistance to chemicals such as household cleaners and sprays and to serve as a flame retardant. It is appreciated that the desired qualities of coating can be depend on the composition and thickness of any underlying plastic or polymer layer, and thus the composition and thickness of one or both of layer and coating can be adjusted to effect the qualities of coating. In one embodiment, photo substrate 110 can be free of a print-receptive coating overlying the plastic or polymer layer, for example where plastic or polymer layer is print receptive. It is further appreciated that the photo substrate 110 can be free of plastic or polymer layer. For example, the print receptive coating can be joined or adhered directly to substrate layer.

Photo substrate 110 can be further optionally treated with a flame retardant to render it flameproof, to hinder damage due to ultraviolet light, moisture or humidity or any combination of the foregoing or any other protective coating which can serve as the top or outer surface of the photo substrate 110. Such a protective coating can overlie the penultimate outer layer of the photo substrate 110, which as discussed above can be the substrate layer, the plastic or polymer layer or the print-receptive coating or can be any other layer of the photo substrate 110.

Any other suitable photo substrate 110 can be used with the support structures of the present disclosure, including the support structures described herein. In one embodiment, for example, the photo substrate 110 can be any flexible material that can be laminated to a support structure of the disclosure. For example, suitable photo substrates include conventional photo paper. A suitable photo substrate 110 can include any metalized paper or plastic film that can be printed on, or any metal or material that looks like metal that can be printed on. For example, a suitable such photo substrate 110 can include an aluminum outer surface that can be printed on. A suitable plastic film can be a film made from polyester. In one embodiment, a suitable photo substrate 110 can be paper or another material that has a wood-textured appearance.

The support structures with a photo substrate 110 mounted thereon of the disclosure can be used for other than photo displays. For example, a photo substrate 110 having a face of a clock printed thereon can be mounted to a support structure and clock mechanics provided inside the support structure to provide a clock. It is appreciated that the disclosure includes any apparatus having a support structure and a photo substrate 110 laminated thereon, including a photo substrate 110 of the disclosure, and electrical mechanisms, mechanical mechanisms, electro-mechanical mechanism or any other mechanism provided in the support structure.

In one embodiment, the photo display of the present disclosure can comprise a photo substrate 110 having opposite first and second surfaces and a central portion and a periphery, a digitally-printed image on the first surface, a backing having a first planar surface and an opposite second surface and an edge extending between the first planar surface and the second surface of the backing, the central portion of the second surface of the photo substrate 110 being secured to the first planar surface of the backing and the periphery of the second surface of the photo substrate 110 extending around the edge of the backing and being secured to at least a portion of the second surface of the backing.

The photo displays described herein are inexpensive alternatives to currently-available photo displays, particularly currently-available photo displays utilizing stretcher bar frames. Despite the innovative and economical support structures of the photo displays herein, several of such photo displays have the appearance of canvas stretched over a stretcher bar frame or other more expensive support structure. The support structures of the photo displays herein use less expensive materials, utilize unique configurations of support elements and are formed in processes capable of automation, thus providing a more economical yet professional looking photo display. The photo displays herein can simulate a stretched and taut canvas or other photo substrate 110, thus being capable of providing a planar image. Additionally, the photo displays herein can be easily scaled to accommodate both small and large images.

The photo substrate 110 herein can have the appearance of an artist's canvas, and may or may not include a woven textile layer. Where a woven textile layer is utilized, such woven textile layer can be relatively lightweight so as to be relatively inexpensive. Where a paper layer is utilized in place of a woven textile layer, further cost reductions can be provided.

The photo substrate 110 herein, and as illustrated on the support structures herein, can extend across greater or lesser portions of the support structures than as described or illustrated herein. For example, the photo substrate 110 need not extend to the rear of the support structures, need not extend to the sides of the support structures and need not extend all of the front of the support structure. The image formed on the outer surface of the photo substrate 110 herein can extend across all or any portion of such outer surface, regardless of the position of the photo substrate 110 on the respective support structure.

Each of the photo substrates 110 herein can be used with each of the support structures herein or any other support structure, including any conventional support structure such as a conventional stretcher bar frame and any support structure having the appearance of a stretcher bar frame. Each of the support structures herein can be used with any photo substrate 110, including any conventional photo substrate 110 and any photo substrate 110 resembling artist canvas.

In certain aspects, the photo substrate 110 on the support structure has been cut so as to remove any flaps or excess material at the corners of the support structure. In other aspects, the photo display is configured so that there is no back sheet or additional material attached to the support structure other than the central sheet 105 with the adhered photo substrate 110. Thus, in one embodiment the photo display does not comprise flaps at the corners from the photo substrate 110 and/or canvas-like material nor does it have any backing such as a back sheet attached to the support structure.

As used herein, the terms “front,” “back,” and/or other terms indicative of direction are used herein for convenience and to depict relational positions and/or directions between the parts of the embodiments. It will be appreciated that certain embodiments, or portions thereof, can also be oriented in other positions. In addition, the term “about” should generally be understood to refer to both the corresponding number and a range of numbers. In addition, all numerical ranges herein should be understood to include each whole integer or fraction thereof within the range.

While the disclosure has been described in connection with specific embodiments thereof, it will be understood that it is capable of further modifications and this application is intended to cover any variations, uses, or adaptations of the disclosure following, in general, the principles of the disclosure and including such departures from the present disclosure as come within known or customary practice within the art to which the disclosure pertains and as may be applied to the essential features hereinbefore set forth and as follows in the scope of the appended claims.

We claim:

1. A photo display, comprising a photo substrate having opposite first and second surfaces and a central and peripheral portions, an image printed on the first surface, a support structure including a rectangular central sheet, four base side strips, four internal side strips, four back strips, four external side strips,
the central sheet having a front and a rear and four edges at its periphery and the external side strips extending alongside respective edges of the central sheet at a right angle to the central sheet, the external side strips having respective opposite ends extending end-to-end to form four external corners,
the back strips extending along respective external side strips at a right angle to the external side strips, the back strips having respective opposite ends extending end-to-end overlying the periphery of the central sheet,
the internal side strips extending along respective back strips at a right angle to the back strips, the internal side strips having respective opposite ends extending end-to-end to form four internal corners,
the base side strips extending along respective internal side strips at a right angle to the internal side strips, the base side strips having respective opposite ends extending end-to-end and lying flat against the central sheet,
the central sheet, four base side strips, four internal side strips, four back strips, four external side strips being made of paperboard, cardboard, fiberboard, wood, metal, plastic, or a combination thereof,
the second surface of the photo substrate adhered to the front of the central sheet so that the central sheet forms a rigid backing for the central portion of the photo substrate and the peripheral portions of the photo substrate adhered to the external side strips and back strips,
securement means for coupling the four base side strips to the central sheet and/or holding the four external corners and the four internal corners in place.

2. The photo display of claim 1, where in the securement means is glue or staples.

3. The photo display of claim 1, wherein the central sheet, four base side strips, four internal side strips, four back strips, four external side strips are made of paperboard and/or fiberboard.

4. The photo display of claim 1, wherein the photo substrate comprises a textile-like material.

5. The photo display of claim 4, wherein the textile-like material comprises a layer of woven textile.

6. The photo display of claim 1, wherein the photo substrate is an artist canvas.

7. The photo display of claim 1, wherein the image is printed on the first surface with digital printing, offset lithography, letterpress, flexography, gravure, silk-screening, blocking, embossing and/or thermography.

8. The photo display of claim 7, wherein the digital printing is inkjet printing or laser printing.

9. A photo display, comprising a photo substrate having opposite first and second surfaces and a central and peripheral portions, an image printed on the first surface, a support structure including a rectangular central sheet, four base side strips, four internal side strips, four back strips, four external side strips,
the central sheet having a front and a rear and four edges at its periphery and the external side strips extending alongside respective edges of the central sheet at a right angle to the central sheet, the external side strips having respective opposite ends extending end-to-end to form four external corners,
the back strips extending along respective external side strips at a right angle to the external side strips, the back strips having respective opposite ends extending end-to-end overlying the periphery of the central sheet,
the internal side strips extending along respective back strips at a right angle to the back strips, the internal side strips having respective opposite ends extending end-to-end to form four internal corners,
the base side strips extending along respective internal side strips at a right angle to the internal side strips, the base side strips having respective opposite ends extending end-to-end and lying flat against the central sheet,
the central sheet, four base side strips, four internal side strips, four back strips, four external side strips being made of fiberboard,
the second surface of the photo substrate adhered to the front of the central sheet so that the central sheet forms a rigid backing for the central portion of the photo substrate and the peripheral portions of the photo substrate adhered to the external side strips and back strips,
securement means for coupling the four base side strips to the central sheet and/or holding the four external corners and the four internal corners in place.

10. The photo display of claim 9, where in the securement means is glue or staples.

11. The photo display of claim 9, wherein the photo substrate comprises a textile-like material.

12. The photo display of claim 11, wherein the textile-like material comprises a layer of woven textile.

13. The photo display of claim 9, wherein the photo substrate is an artist canvas.

14. The photo display of claim 9, wherein the image is printed on the first surface with digital printing, offset lithography, letterpress, flexography, gravure, silk-screening, blocking, embossing and/or thermography.

15. The photo display of claim 14, wherein the digital printing is inkjet printing or laser printing.
